(19) United States
(12) Patent Application Publication
(10) Pub. No.: US 2025/0302076 A1
(43) Pub. Date: Oct. 2, 2025

(54) NUTRACEUTICAL COMPOSITION FOR COMBATING AGING IN HUMAN AND NON-HUMAN ANIMALS AND BEVERAGES AND/OR FOOD PRODUCTS AND/OR FOOD SUPPLEMENTS CONTAINING THE SAME

(71) Applicants: DOUGLAS JAY SPIEL, PERRINEVILLE, NJ (US); RAYMOND ANTHONY JOAO, YONKERS, NY (US)

(72) Inventors: DOUGLAS JAY SPIEL, PERRINEVILLE, NJ (US); RAYMOND ANTHONY JOAO, YONKERS, NY (US)

(21) Appl. No.: 19/094,666

(22) Filed: Mar. 28, 2025

Related U.S. Application Data
(60) Provisional application No. 63/572,189, filed on Mar. 30, 2024.

(51) Int. Cl. A23L 2/66; A23L 2/02; A23L 2/38; A23L 2/39; A23L 29/00; A23L 33/105; A23L 33/175

(52) U.S. Cl. CPC A23L 2/66; A23L 2/02; A23L 2/38; A23L 2/39; A23L 29/035; A23L 33/105; A23L 33/175

(57) ABSTRACT

A nutraceutical composition, consisting of at least of Berberine in a range of 500-1500 mg, Trimethylglycine (TMG) in a range of 500-2000 mg, Microdose Lithium in range of 1-5 mg, Epigallocatechin-3-gallate (EGCG) in a range of 100-500 mg, Fisetin in a range of 100-1000 mg, Resveritrol in a range of 150-1000 mg, Glutathione in a range of 250-1000 mg, Nicotinamide Mononucleotide (NMN) in a range of 250-1000 mg or Nicotinamide Riboside (NR) in a range of 100-2000 mg, Calcium Alphaketoglutarate (CaAKG) in a range of 300-2000 mg, Spermidine in a range of 0.5-10 mg, Urolithin A in a range of 250-2000 mg, Hyaluronic acid in a range of 100-240 mg, Fucoidan in a range of 100-4000 mg, and Sodium Butyrate in a range of 100-3000 mg.

### RELATED APPLICATIONS

This application claims the benefit of the priority of U.S. Provisional Patent Application Ser. No. 63/572,189, filed Mar. 30, 2024, and entitled “NUTRACEUTICAL COMPOSITION FOR COMBATING AGING IN HUMAN AND NON-HUMAN ANIMALS AND BEVERAGES AND/OR FOOD PRODUCTS AND/OR FOOD SUPPLEMENTS CONTAINING THE SAME”, the subject matter and teachings of which are hereby incorporated by reference herein in their entirety.

### FIELD OF THE INVENTION

The present invention pertains to a nutraceutical composition for combating aging in human and non-human animals and beverages, and/or food products, and/or food supplements, containing the same and, in particular, the present invention pertains to a nutraceutical composition for combating aging in human and non-human animals and beverages, and/or food products, and/or food supplements, containing the same which contain a combination of nutraceutical substances and/or products which address, and/or which subserve and/or which can serve to promote and/or facilitate the combating of, each one of twelve identified pillars of aging.

### BACKGROUND OF THE INVENTION

While the field of aging is an evolving science, it is clear that normal aging inevitably leads to age-related diseases. It is, therefore, of paramount importance to slow the aging process to stave off these afflictions. Clinicians and scientists have attempted to quantify the deficiencies of aging into discrete pillars so that the they can be better characterized and understood. There are many food and drink products, including, but not limited to, various beverage products, powdered products, chewable products, and/or foods products, which are offered in the marketplace which are touted as having various health benefits, nutritional benefits, energy enhancing benefits, and even anti-aging benefits. It is submitted, however, that while these various products might provide certain benefits, they still lack in their ability to provide longevity or to provide optimal longevity.

While various products, such as certain nutraceutical products, are known and available in the marketplace, it is submitted that no one particular nutraceutical product can effectively combat all of the various pillars of aging, and it is submitted that all of the pillars of aging must be combated in order to maximize an individual's longevity.

It is submitted that there are twelve pillars of aging which must be addressed in order to follow a proper longevity nutrition regime. It is submitted that the twelve pillars of aging include: 1) genomic instability; 2) telomere attrition; 3) epigenetic alterations; 4) loss of proteostasis; 5) deregulated nutrient sensing; 6) mitochondrial dysfunction; 7) cellular senescence; 8) stem cell exhaustion; 9) altered intercellular communication; 10) extracellular matrix stiffness; 11) altered cellular metabolism/autophagy; and 12) inflammation.

It is submitted that there currently exists no product in the marketplace which can improve and/or maximize one's longevity which effectively addresses and effectively combats all of the aforementioned twelve pillars of aging. Further, it is submitted that there are currently no products in the marketplace which utilize various nutraceutical products and ingredients in sufficient quantities necessary to, provide, in a single serving, a longevity product which effectively addresses and effectively combats the aforementioned twelve pillars of aging.

As a result, consumers are forced to pour through numerous online companies, vitamin stores, and pharmaceutical supply companies, in order to obtain each of the various and individual supplements needed, and/or to piecemeal combine them together, in order to create their own homemade longevity cocktails or food products. It is also submitted that even those self-proclaimed providers of products or ingredients for combating aging typically require consumers to further combine these products or ingredients with other products or ingredients which can result in cocktails or food products which have insufficient dosages to effectively combat aging and the twelve pillars of aging. Further, the average consumer typically lacks the requisite knowledge to create their own blend of nutraceutical products and ingredients in order to address and effectively combat the twelve pillars of aging.

In view of the foregoing, it is submitted that no nutraceutical composition exists in the marketplace which addresses and combats all of the twelve pillars of aging in an effective and efficient manner.

### SUMMARY OF THE INVENTION

The present invention pertains to a nutraceutical composition for combating aging in human and non-human animals and beverages, and/or food products, and/or food supplements, containing the same and, in particular, the present invention pertains to a nutraceutical composition for combating aging in human and non-human animals and beverages, and/or food products, and/or food supplements containing the same, which contain a combination of nutraceutical substances and/or products which address, and/or which subserve and/or which can serve to promote and/or facilitate the combating of, each one of twelve identified pillars of aging, which overcome the shortcomings and shortfalls of prior art compositions and substances.

The present invention is, and provides, a nutraceutical composition which includes, but which is not limited to, at least the following 17 nutraceutical ingredients (referred to hereinafter as the “17 core nutraceutical ingredients”): 1) Berberine; 2) Trimethylglycine (TMG); 3) Microdose Lithium; 4) Epigallocatechin-3-gallate (EGCG); 5). Quercetin; 6) Fisetin; 7). Turmeric/Curcumin; 8). Resveritrol; 9). Glutathione; 10) Nicotinamide Mononucleotide (NMN) or Nicotinamide Riboside (NR); 11) Calcium Alphaketoglutarate (CaAKG); 12) Spermidine; 13) Urolithin A; 14) Sulforaphane; 15) Glucosamine; 16) Hyaluronic acid; and 17) Sodium Butyrate.

It is submitted that some of the foregoing 17 core nutraceutical ingredients may yield enhanced absorption in a liposomal preparation such as, for example, glutathione. It is also submitted that some of the 17 core nutraceutical ingredients, along with other nutraceutical ingredients, demonstrate enhanced absorption with co-administration of other compounds such as, for example, curcumin with black pepper (which contains Piperine) and sulforaphane with myrosinase.

It also submitted that many of the nutraceutical ingredients noted above and further listed hereinafter are known to expand lifespan in certain organisms.

At least two or more of the each of the above listed 17 core nutraceutical ingredients can address and combat each of the twelve pillars of aging. In this regard, the 17 core nutraceutical ingredients listed herein can ensure appropriate coverage for addressing and combating each of the twelve pillars of aging.

Any other suitable nutraceutical compounds or nutraceutical ingredients can also be utilized in the present invention in addition to the 17 core nutraceutical ingredients listed above. These additional nutraceutical compounds or nutraceutical ingredients can include, but are not limited to: 1) Pterostilbene; 2) Rhodiola Rosea; 3) Malate (or Malic Acid); 4) L-Theanine; 5) Ginger; 6) Cinnamon; and/or 7) Apigenin.

The nutraceutical composition of the present invention can be manufactured by mixing the above-identified 17 core nutraceutical ingredients, together and/or by processing the same in any, and/or during any, appropriate mixing process or operation, cooking process or operation, homogenization process or operation, pasteurization process or operation, and/or any other appropriate process or operation, and/or any combination of the same, which are known to those having skill in the art of the preparation of food compositions, drug compositions, food supplement compositions, chemical compositions and/or mixtures, beverages, drinks, chewable and/or edible foods, food snack bars, energy bars, energy drinks, protein drinks, and/or any other edible food or beverages which can contain supplements such as those of, and/or provided by, the present invention.

The nutraceutical composition of the present invention can also be manufactured by combining, blending, or mixing, together the above-identified 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, by mixing and/or by processing the same in any, and/or during any, appropriate mixing process or operation, cooking process or operation, homogenization process or operation, pasteurization process or operation, and/or any other appropriate process or operation, and/or any combination of the same, which are known to those having skill in the art of the preparation of food compositions, drug compositions, food supplement compositions, chemical compositions and/or mixtures, beverages, drinks, chewable and/or edible foods, food snack bars, energy bars, energy drinks, and/or any other edible food or beverage which can contain supplements such as those of, and/or provided by, the present invention.

For example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with water, or with any suitable juice or drink, in order to obtain a nutraceutical-base product for providing longevity.

As and for another example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with green tea in order to obtain a nutraceutical-based green tea product for providing longevity.

As and for another example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with black tea in order to obtain a nutraceutical-based black tea product for providing longevity.

As and for still another example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with any type or kind of tea in order to obtain a nutraceutical-based tea product for providing longevity.

As and for yet another example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with any type or kind of coffee, which can be caffeinated coffee, de-caffeinated coffee, or any flavored coffee, in order to obtain a nutraceutical-based coffee product for providing longevity.

As and for another example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with any type or kind of red wine in order to obtain a nutraceutical-based red wine beverage or drink product for providing longevity.

As and for still another example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with any type or kind of diet beverage or drink, nutrition beverage or drink, energy beverage or drink, protein beverage or drink, or any other type or kind of beverage or drink, in order to obtain a nutraceutical-based beverage or drink product for providing longevity.

As and for yet another example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed together in powder form and/or in liquid form, and/or in any combination of the same, and the resulting mixture can be used in producing a chewable food product for providing longevity.

All of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can also be mixed together in powder form and/or in liquid form, and/or in any combination of the same, and the resulting mixture can be used in producing a food product such as food bar, a snack bar, a cookie, a syrup, a drink or beverage additive or supplement, or a food additive or food supplement which can be in liquid form or in powdered form, for providing longevity.

A process for producing the nutraceutical composition of the present invention and/or the beverages, and/or food products, and/or food supplements, containing the same, can be performed by combining, mixing, or blending, in any appropriate order or manner, the above-identified 17 core nutraceutical ingredients, including Berberine, Trimethylglycine, Microdose Lithium; Epigallocatechin-3-gallate (EGCG), Quercetin, Fisetin, Turmeric/Curcumin, Resveritrol, Glutathione, Nicotinamide Mononucleotide (NMN) or Nicotinamide Riboside (NR), Calcium Alphaketoglutarate, Spermidine, Urolithin A, Sulforaphane, Glucosamine, Hyaluronic acid, and Sodium Butyrate, each of which can be in a powdered form and/or in a liquid form, and each of which can be in respective amounts per servings as provided in Table 1, in an appropriate container or containment system.

One or more of the 17 core nutraceutical ingredients can also be placed in a liposomal preparation, such as, for example, one containing glutathione. One or more of the 17 core nutraceutical ingredients can utilize a co-agent which can include curcumin with black pepper (which contains Piperine) and/or sulforaphane with myrosinase.

Any other or additional nutraceutical ingredient(s), such as Pterostilbene, Rhodiola Rosea, Malate (or Malic Acid), L-Theanine, Ginger; Cinnamon, and/or Apigenin, and/or any other suitable nutraceutical ingredient(s), can also be added to the above-described mixture.

The nutraceutical ingredients can thereafter be mixed together by mixing and/or by processing the same in any, and/or during any, appropriate mixing process or operation, cooking process or operation, homogenization process or operation, pasteurization process or operation, and/or any other appropriate process or operation, and/or any combination of the same, which are known to those having skill in the art of the preparation of food compositions, drug compositions, food supplement compositions, chemical compositions and/or mixtures, beverages, drinks, chewable and/or edible foods, food snack bars, energy bars, energy drinks, and/or any other edible food or beverage which can contain supplements such as those of, and/or provided by, the present invention.

The nutraceutical ingredients which are utilized can be mixed together so as to yield the resulting nutraceutical composition of the present invention. The resulting nutraceutical composition can be in liquid form or in powdered form. If a powdered form is desired from a resulting liquid nutraceutical composition, an appropriate de-hydration process or operation can be performed in the container or containment system and/or in a second or other container or containment system.

Thereafter, the resulting nutraceutical composition can be in liquid form or in powdered form can be utilized in any appropriate manner, such as in producing a longevity nutraceutical-based beverage, a longevity nutraceutical-based drink, a longevity nutraceutical-based chewable food product, a longevity nutraceutical-based food product such as food bar, a snack bar, a cookie, or a syrup, a longevity nutraceutical-based drink or beverage additive or supplement, or a longevity nutraceutical-based food additive or food supplement.

The respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement, can be produced using the nutraceutical composition (also referred to as the “resulting nutraceutical composition”) which was produced. The respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement, can be produced using any respective, suitable, and/or appropriate method(s), technique(s), process(es), and/or operation(s) known by those skilled in the art of food production or manufacturing, beverage or drink production or manufacturing, food supplement production or manufacturing, and/or beverage or drink supplement production or manufacturing.

Any natural flavoring(s) and/or any artificial flavoring(s) can also be added to the respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement.

The present invention is, and provides, a nutraceutical composition which also can include a reduced number of nutraceutical ingredients while still providing for the addressing and the combating of all twelve of the pillars of aging. In one such preferred embodiment, thirteen or more nutraceutical ingredients can be utilized which can be selected from among the following 24 nutraceutical ingredients: 1) Berberine; 2) Trimethylglycine (TMG); 3) Microdose Lithium; 4) Epigallocatechin-3-gallate (EGCG); 5). Quercetin; 6) Fisetin; 7). Turmeric/Curcumin; 8) Resveritrol; 9). Glutathione; 10) Nicotinamide Mononucleotide (NMN) or Nicotinamide Riboside (NR); 11) Calcium Alphaketoglutarate (CaAKG); 12) Spermidine; 13) Urolithin A; 14) Sulforaphane; 15) Glucosamine; 16) Hyaluronic acid; 17) Sodium Butyrate; 18) Pterostilbene; 19) Rhodiola Rosea; 20) Malate (or Malic Acid); 21) L-Theanine; 22) Ginger; 23) Cinnamon; and 24) Apigenin. The above 24 nutraceutical ingredients, along with suggested dosages per serving of nutraceutical composition, are listed in TABLE 2.

Less than thirteen of the foregoing 24 nutraceutical ingredients, or any other nutraceutical ingredients not identified herein, can also be utilized provided the nutraceutical composition formed thereby can effectively address and combat all twelve of the pillars of aging in an effective manner.

At least the following thirteen nutraceutical ingredients can be utilized in producing the nutraceutical composition of the present invention: 1) Berberine; 2) Trimethylglycine (TMG); 3) Microdose Lithium; 4) Epigallocatechin-3-gallate (EGCG); 5) Fisetin; 6) Resveritrol; 7) Glutathione; 8) Nicotinamide Mononucleotide (NMN) or Nicotinamide Riboside (NR); 9) Calcium Alphaketoglutarate (CaAKG); 10) Spermidine; 11) Urolithin A; 12) Hyaluronic acid; and 13) Sodium Butyrate.

Additionally, one or more of any other nutraceutical ingredients identified herein, or any other appropriate and/or suitable nutraceutical ingredient(s) not described herein, can also be utilized along with the above 13 listed nutraceutical ingredients.

At least the above listed 13 nutraceutical ingredients, can be utilized to provide for a minimal or a reduced number of nutraceutical ingredients which can effectively address and combat all twelve of the pillars of aging. All of the at least 13 nutraceutical ingredients, and/or any one or more of the other herein-mentioned additional nutraceutical compounds or nutraceutical ingredients, and/or any other suitable or appropriate nutraceutical compounds or nutraceutical ingredients, can also be mixed together in powder form and/or in liquid form, and/or in any combination of the same, and the resulting mixture can be used in producing a food product such as food bar, a snack bar, a cookie, a syrup, a drink or beverage additive or supplement, or food additive or food supplement which can be in liquid form or in powdered form, for providing longevity.

A process for producing the nutraceutical composition of the present invention and/or the beverages, and/or food products, and/or food supplements, containing the same, can be performed by combining, mixing, or blending, in any appropriate order or manner, the at least 13 nutraceutical ingredients, along with any other nutraceutical ingredient(s), if utilized, each of which can be in a powdered form and/or in a liquid form, and each of which can be in respective amounts per servings as provided in Table 1 or in Table 2, in an appropriate container or containment system.

One or more of the nutraceutical ingredients can also be placed in a liposomal preparation, such as, for example, one containing glutathione. One or more of the nutraceutical ingredients can also utilize a co-agent which can include curcumin with black pepper (which contains Piperine) and/or sulforaphane with myrosinase.

The nutraceutical ingredients can thereafter be mixed together by mixing and/or by processing the same in any, and/or during any, appropriate mixing process or operation, cooking process or operation, homogenization process or operation, pasteurization process or operation, and/or any other appropriate process or operation, and/or any combination of the same, which are known to those having skill in the art of the preparation of food compositions, drug compositions, food supplement compositions, chemical compositions and/or mixtures, beverages, drinks, chewable and/or edible foods, food snack bars, energy bars, energy drinks, and/or any other edible food or beverage which can contain supplements such as those of, and/or provided by, the present invention.

As noted above, the nutraceutical ingredients which are utilized can be mixed together so as to yield the resulting nutraceutical composition of the present invention. As is also noted above, the resulting nutraceutical composition can be in liquid form or in powdered form. If a powdered form is desired from a resulting liquid nutraceutical composition, an appropriate de-hydration process or operation can be performed in the container or containment system and/or in a second or other container or containment system.

The nutraceutical composition of the present invention can also contain the nutraceutical Fucoidan in a range of 100-4000 mg. The Fucoidan can be an additional ingredient in any nutraceutical composition of, and prepared pursuant to, the present invention. Fucoidan can be used as a suitable substitute for any ingredient in any nutraceutical composition of, and prepared pursuant to, the present invention.

The nutraceutical composition of the present invention can also contain the nutraceutical Cacao in any suitable and safe amount or range provided that said amount does not exceed any safe or recommended daily dosage amount or range. The Cacao can be an additional ingredient in any nutraceutical composition of, and prepared pursuant to, the present invention. Cacao can be used as a suitable substitute for any ingredient in any nutraceutical composition of, and prepared pursuant to, the present invention.

The nutraceutical composition of the present invention can be manufactured and sold in powder form as a powder which can be added to, and/or mixed with, any drink or beverage, or which can be added to, and/or mixed with, any food. The nutraceutical composition of the present invention, which can be manufactured as a powder, can be flavored with any appropriate and/or suitable flavor or flavoring, which flavor or flavoring can be, or can include, a natural flavor or flavoring or any combination of natural flavors or flavorings.

The nutraceutical composition of the present invention, which can be manufactured as a powder, can be flavored with any appropriate and/or suitable flavor or flavoring, which flavor or flavoring can be, or can include, an artificial flavor or flavoring or any combination of artificial flavors or flavorings.

The nutraceutical composition of the present invention, which can be manufactured as a powder, can be flavored with any appropriate and/or suitable flavor or flavoring, which flavor or flavoring can be, or can include, any combination of a natural flavor or flavoring and an artificial flavor or flavoring or any combination of an artificial flavor or flavoring and one or more natural flavor(s) or flavoring(s) or any combination of a natural flavor or flavoring and one or more artificial flavor(s) or flavoring(s).

The nutraceutical composition of the present invention, which can be manufactured as a powder, can also be non-flavored.

The nutraceutical composition of the present invention, which can be manufactured as a powder, can also produced with caffeine as a caffeinated product. The nutraceutical composition of the present invention, which can be manufactured as a powder, can also produced with without caffeine as a non-caffeinated product or as a de-caffeinated product.

The nutraceutical composition of the present invention can also be produced or manufactured as a concentrated liquid or as a syrup which can be added to, and/or mixed with, any drink or beverage, or which can be added to, and/or mixed with, any food. The nutraceutical composition of the present invention, which can also be produced as a concentrated liquid or as a syrup, can be flavored with any natural flavor or flavoring, or can be flavored with any artificial flavor or flavoring, or can be flavored with any combination of one or more natural flavor(s) or flavoring(s) and one or artificial flavor(s) or flavoring(s). The nutraceutical composition of the present invention, which can also be produced as a concentrated liquid or as a syrup, can be unflavored. The herein-described nutraceutical composition of the present invention, which can also be produced as a concentrated liquid or as a syrup, can be caffeinated or can be uncaffeinated or de-caffeinated.

The herein-identified nutraceutical ingredients, including, but not limited to, Berberine, Trimethylglycine (TMG), Microdose Lithium, Epigallocatechin-3-gallate (EGCG), Fisetin, Resveritrol, Glutathione, Nicotinamide Mononucleotide (NMN) or Nicotinamide Riboside (NR), Calcium Alphaketoglutarate (CaAKG), Spermidine, Urolithin A, and Hyaluronic acid, or any combination of any of the herein-identified nutraceutical ingredients, which can include any of the ingredients identified in Table 2 and/or Fucoidan and/or cacao, can also be utilized to provide for a nutraceutical composition which can effectively address and combat all twelve of the pillars of aging.

The nutraceutical composition of the present invention can be mixed and/or processed in order to yield a nutraceutical composition in a powder form or powdered form which can be added to, or mixed into and/or with, water or any suitable liquid drink or beverage, or a juice, coffee, tea, or any other type or kind of beverage. The nutraceutical composition of the present invention can be mixed and/or processed in order to yield a nutraceutical composition in a powder form or powdered form which can be added to, or mixed into and/or with, any cold liquid or beverage or any hot or warm liquid of beverage.

For example, the nutraceutical composition in powder form or powdered form can be packaged in a stick package, in a stick packet, or/and in any suitable packet or packaging. Such a packaged nutraceutical composition provided in powder form can be mixed into or with any water or other liquid or beverage.

The nutraceutical composition of the present invention can be mixed and/or processed in order to yield a nutraceutical composition in a liquid form or in a syrup form, which nutraceutical composition can be added to, or mixed into and/or with, water or any suitable liquid drink or beverage, or a juice, coffee, tea, or any other type or kind of beverage.

The nutraceutical composition of the present invention, in a liquid form or in a syrup form, can be added to, or mixed into and/or with, any cold liquid or beverage or any hot or warm liquid of beverage. For example, the nutraceutical composition in liquid form or in syrup form can be packaged in any suitable container, bottle, or can, made of any suitable material. In a preferred embodiment, such a packaged nutraceutical composition, in liquid form or in syrup form can be mixed into or with any water or other liquid or beverage.

The herein-identified nutraceutical ingredients, and/or Fucoidan and/or cacao, can be utilized to provide for a nutraceutical composition which can effectively address and combat all twelve of the pillars of aging.

The nutraceutical composition of the present invention can be mixed and/or processed in order to yield a nutraceutical composition in a powder form or powdered form which can be added to, or mixed into and/or with, water or any suitable liquid drink or beverage, or a juice, coffee, tea, or any other type or kind of beverage. The nutraceutical composition of the present invention can be mixed and/or processed in order to yield a nutraceutical composition in a powder form or powdered form which can be added to, or mixed into and/or with, any cold liquid or beverage or any hot or warm liquid of beverage. For example, the nutraceutical composition in powder form or powdered form can be packaged in a stick package, in a stick packet, or/and in any suitable packet or packaging. Such a packaged nutraceutical composition provided in powder form can be mixed into or with any water or other liquid or beverage.

The nutraceutical composition of the present invention can be mixed and/or processed in order to yield a nutraceutical composition in a liquid form or in a syrup form which nutraceutical composition can be added to, or mixed into and/or with, water or any suitable liquid drink or beverage, or a juice, coffee, tea, or any other type or kind of beverage. The nutraceutical composition of the present invention, in a liquid form or in a syrup form, can be added to, or mixed into and/or with, any cold liquid or beverage or any hot or warm liquid of beverage. The nutraceutical composition in liquid form or in syrup form can be packaged in any suitable container, bottle, or can, made of any suitable material. Such a packaged nutraceutical composition, in liquid form or in syrup form can be mixed into or with any water or other liquid or beverage.

Thereafter, the resulting nutraceutical composition can be in liquid form or in powdered form can be utilized in any appropriate manner, such as in producing a longevity nutraceutical-based beverage, a longevity nutraceutical-based drink, a longevity nutraceutical-based chewable food product, a longevity nutraceutical-based food product such as food bar, a snack bar, a cookie, or a syrup, a longevity nutraceutical-based drink or beverage additive or supplement, or a longevity nutraceutical-based food additive or food supplement.

The respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement, can be produced using the nutraceutical composition which was produced. The respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement, can be produced using any respective, suitable, and/or appropriate method(s), technique(s), process(es), and/or operation(s) known by those skilled in the art of food production or manufacturing, beverage or drink production or manufacturing, food supplement production or manufacturing, and/or beverage or drink supplement production or manufacturing.

As also noted herein, any natural flavoring(s) and/or any artificial flavoring(s) can also be added to the respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement.

As noted above, the nutraceutical composition of the present invention can also be produced from less than thirteen nutraceutical ingredients, with the minimum number only being limited depending upon the effective addressing and effective combating of the all twelve of the pillars of aging.

The nutraceutical composition of the present invention can be used to provide a pre-packaged beverage or drink, a pre-packaged tea beverage or drink, a pre-packaged coffee beverage or drink, a pre-packaged red wine beverage or drink, a pre-packaged carbonated beverage or drink, a pre-packaged caffeinated beverage or drink, a product which can be offered in powered powdered form, a chewable food product, a food product, a food snack bar product, a food supplement product which can be provided in liquid form or in powdered form, and/or any other consumable beverage, drink, edible product, food product, or food supplement. In a preferred embodiment, the present invention can provide a nutraceutical composition which can be consumed in any beverage, drink, edible, food product, or food supplement, daily by itself as a stand alone supplement and/or as a daily solution to address and combat the problem of aging while dispensing with the need to obtain and mix the individual ingredients prior to consumption.

The present invention can provide a food product containing the nutraceutical composition which can be a food supplement which can be added to a food, a beverage, or a drink.

The present invention can provide a food product containing the nutraceutical composition which can be a food supplement which can be applied to a food, a beverage, or a drink. The food product or food supplement of the present invention can also be sprinkled or poured on or over, or into, any food, beverage, or drink.

It is submitted that the nutraceutical composition of the present invention and any products containing the same can provide benefits in and to all major organ systems. These benefits could include, but are not limited to, improved metabolic health, improved cardiovascular health, decreased inflammation, enhanced anti-oxidant benefits, cancer prevention, improved gastrointestinal health, neuroprotection, mood stabilization, improved cognitive health, improved brain health, improved and enhanced antibacterial and anti-viral support, improved and enhanced immune system support, improved respiratory health, improved and enhanced exercise performance and recovery, improved skin health, improved joint health, improved liver health, improved blood sugar control, improved weight management, improved detoxification, improved cellular health and repair, improved energy metabolism, improved protein synthesis, improved wound healing, improved cellular health, improved mitochondrial health, and improved and enhanced life span extension.

The nutraceutical composition of the present invention serves to address and combat the twelve pillars of aging. Further, the nutraceutical composition of the present invention serves to address and combat the twelve pillars of aging in an efficient and effective manner.

Applicant hereby incorporates by reference herein all processes, proprietary and non-proprietary, which are known to those skilled in the pertinent and respective art(s), as of the date of the filing of this patent application, in order to perform any of the method(s), technique(s), process(es), and/or operation(s), needed or desired in performing any of the food production or manufacturing, the beverage or drink production or manufacturing, the food supplement production or manufacturing, and/or the beverage or drink supplement production or manufacturing, in producing any beverages, drinks, foods, and/or food supplements, described herein as being produced using any of the nutraceutical compositions of the present invention.

Applicant also hereby incorporates by reference herein the subject matter and teachings of U.S. Pat. No. 11,839,622, entitled “CONSUMABLE NUTRACEUTICAL COMPOSITION”, the subject matter and teachings of which are incorporated by reference herein in their entirety, as if to be fully restated herein, so as incorporate the teachings of same, and so as to improve upon the teachings of the same.

The nutraceutical composition of the present invention can also be produced so as to include any types or kinds of ingredients typically found in energy drinks, protein drinks, vitamin drinks, energy foods, protein foods, vitamin-enriched foods, energy food and/or beverage supplements, protein food and/or beverage supplements, and/or vitamin food and/or beverage supplements.

### BRIEF DESCRIPTION OF THE DRAWINGS

In the Drawings:

FIG. 1 illustrates a preferred embodiment method for producing the nutraceutical composition of the present invention and any food or beverage products and/or food or beverage supplements containing the same; and

FIG. 2 illustrates another preferred embodiment method for producing a nutraceutical composition of the present invention, using a reduced number of nutraceutical ingredients, and any food or beverage products and/or food or beverage supplements containing the same.

FIG. 3 illustrates another preferred embodiment method for producing a nutraceutical composition of the present invention in a powder form or powdered form; and

FIG. 4 illustrates another preferred embodiment method for producing a nutraceutical composition of the present invention in a liquid form or in a syrup form.

### DESCRIPTION OF THE PREFERRED EMBODIMENTS

The present invention pertains to a nutraceutical composition for combating aging in human and non-human animals and beverages, and/or food products, and/or food supplements containing the same, and, in particular, the present invention pertains to a nutraceutical composition for combating aging in human and non-human animals and beverages, and/or food products, and/or food supplements containing the same, which contain a combination of nutraceutical substances and/or products which address, and/or which subserve and/or which can serve to promote and/or facilitate the combating of, each one of twelve identified pillars of aging.

Applicant hereby incorporates by reference herein the subject matter and teachings of U.S. Provisional Patent Application Ser. No. 63/572,189, filed Mar. 30, 2024, and entitled “NUTRACEUTICAL COMPOSITION FOR COMBATING AGING IN HUMAN AND NON-HUMAN ANIMALS AND BEVERAGES AND/OR FOOD PRODUCTS AND/OR FOOD SUPPLEMENTS CONTAINING THE SAME”, the subject matter and teachings of which are hereby incorporated by reference herein in their entirety.

In a preferred embodiment, the present invention is, and provides, a nutraceutical composition which includes, but which is not limited to, at least the following 17 nutraceutical ingredients (referred to hereinafter as the “17 core nutraceutical ingredients”):
1. Berberine;
2. Trimethylglycine (TMG);
3. Microdose Lithium;
4. Epigallocatechin-3-gallate (EGCG)
5. Quercetin;
6. Fisetin;
7. Turmeric/Curcumin;
8. Resveritrol;
9. Glutathione;
10. Nicotinamide Mononucleotide (NMN) or Nicotinamide Riboside (NR);
11. Calcium Alphaketoglutarate (CaAKG);
12. Spermidine;
13. Urolithin A;
14. Sulforaphane;
15. Glucosamine;
16. Hyaluronic acid; and
17. Sodium Butyrate.

It is submitted that some of the foregoing 17 core nutraceutical ingredients may yield enhanced absorption in a liposomal preparation such as, for example, glutathione. It is also submitted that some of the 17 core nutraceutical ingredients, along with other nutraceutical ingredients, demonstrate enhanced absorption with co-administration of other compounds such as, for example, curcumin with black pepper and sulforaphane with myrosinase.

It also submitted that many of the nutraceutical ingredients noted above and further listed hereinafter are known to expand lifespan in certain organisms.

In a preferred embodiment, at least two or more of the each of the above listed 17 core nutraceutical ingredients can address and combat each of the twelve pillars of aging. In this regard, the present invention and the 17 core nutraceutical ingredients listed herein can ensure appropriate coverage for addressing and combating each of the twelve pillars of aging.

In a preferred embodiment, any other suitable nutraceutical compounds or nutraceutical ingredients can also be utilized in the present invention in addition to the 17 core nutraceutical ingredients listed above. These additional nutraceutical compounds or nutraceutical ingredients can include, but are not limited to: 1) Pterostilbene; 2) Rhodiola Rosea; 3) Malate (or Malic Acid); 4) L-Theanine; 5) Ginger; 6) Cinnamon; and/or 7) Apigenin.

In a preferred embodiment, the nutraceutical composition of the present invention can be manufactured by mixing the above-identified 17 core nutraceutical ingredients, together and/or by processing the same in any, and/or during any, appropriate mixing process or operation, cooking process or operation, homogenization process or operation, pasteurization process or operation, and/or any other appropriate process or operation, and/or any combination of the same, which are known to those having skill in the art of the preparation of food compositions, drug compositions, food supplement compositions, chemical compositions and/or mixtures, beverages, drinks, chewable and/or edible foods, food snack bars, energy bars, energy drinks, protein drinks, and/or any other edible food or beverages which can contain supplements such as those of, and/or provided by, the present invention.

In another preferred embodiment, the nutraceutical composition of the present invention can also be manufactured by combining, blending, or mixing, together the above-identified 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, by mixing and/or by processing the processing the same in any, and/or during any, appropriate mixing process or operation, cooking process or operation, homogenization process or operation, pasteurization process or operation, and/or any other appropriate process or operation, and/or any combination of the same, which are known to those having skill in the art of the preparation of food compositions, drug compositions, food supplement compositions, chemical compositions and/or mixtures, beverages, drinks, chewable and/or edible foods, food snack bars, energy bars, energy drinks, and/or any other edible food or beverage which can contain supplements such as those of, and/or provided by, the present invention.

In another preferred embodiment, for example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with water, or with any suitable juice or drink, in order to obtain a nutraceutical-base product for providing longevity.

In another preferred embodiment, for example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with green tea in order to obtain a nutraceutical-based green tea product for providing longevity.

In another preferred embodiment, for example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with black tea in order to obtain a nutraceutical-based black tea product for providing longevity.

In another preferred embodiment, for example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with any type or kind of tea in order to obtain a nutraceutical-based tea product for providing longevity.

In another preferred embodiment, for example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with any type or kind of coffee, which can be caffeinated coffee, de-caffeinated coffee, or any flavored coffee, in order to obtain a nutraceutical-based coffee product for providing longevity.

In another preferred embodiment, for example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with any type or kind of red wine in order to obtain a nutraceutical-based red wine beverage or drink product for providing longevity.

In another preferred embodiment, for example, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed with any type or kind of diet beverage or drink, nutrition beverage or drink, energy beverage or drink, protein beverage or drink, or any other type or kind of beverage or drink, in order to obtain a nutraceutical-based beverage or drink product for providing longevity.

In another preferred embodiment, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed together in powder form and/or in liquid form, and/or in any combination of the same, and the resulting mixture can be used in producing a chewable food product for providing longevity.

In another preferred embodiment, all of the 17 core nutraceutical ingredients, and/or any one or more of the 7 herein-mentioned additional nutraceutical compounds or nutraceutical ingredients, and/or any other suitable or appropriate nutraceutical compounds or nutraceutical ingredients, can be mixed together in powder form and/or in liquid form, and/or in any combination of the same, and the resulting mixture can be used in producing a food product such as food bar, a snack bar, a cookie, a syrup, a drink or beverage additive or supplement, or food additive or food supplement which can be in liquid form or in powdered form, for providing longevity.

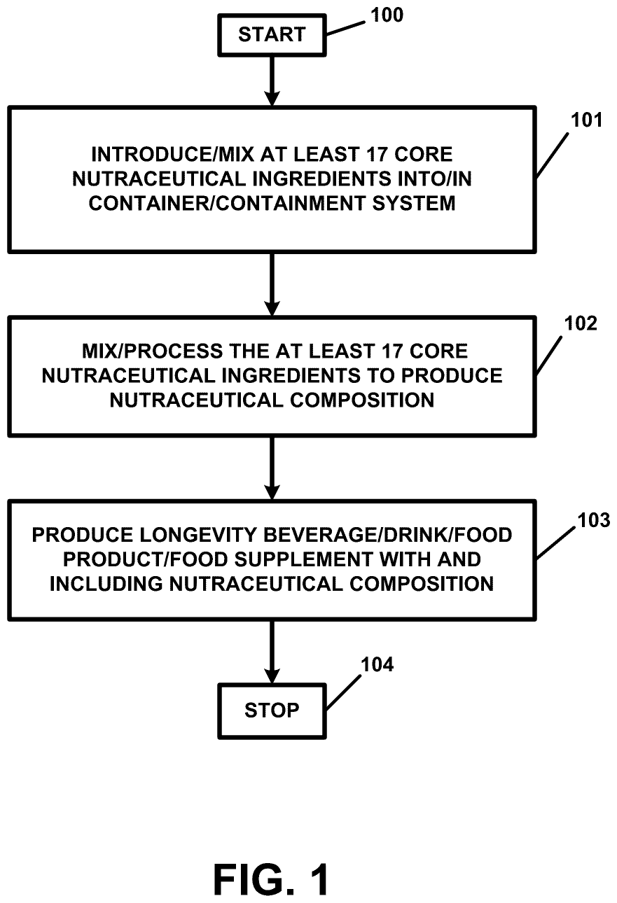

FIG. 1 illustrates a preferred embodiment method for producing the nutraceutical composition of the present invention and any food or beverage products and/or food or beverage supplements containing the same.

With reference to FIG. 1, the process for producing the nutraceutical composition of the present invention and/or the beverages, and/or food products, and/or food supplements, containing the same, commences at step 100. In a preferred embodiment, at step 101, the above-identified 17 core nutraceutical ingredients, including Berberine, Trimethylglycine, Microdose Lithium; Epigallocatechin-3-gallate (EGCG), Quercetin, Fisetin, Turmeric/Curcumin, Resveritrol, Glutathione, Nicotinamide Mononucleotide (NMN) or Nicotinamide Riboside (NR), Calcium Alphaketoglutarate, Spermidine, Urolithin A, Sulforaphane, Glucosamine, and Hyaluronic acid, each of which can be in a powdered form and/or in a liquid form, and each of which can be in respective amounts per servings as provided in Table 1, can be mixed together in any appropriate order or manner in an appropriate container or containment system.

In a preferred embodiment, at step 101, one or more of the 17 core nutraceutical ingredients can also be placed in a liposomal preparation, such as, for example, one containing glutathione. In another preferred embodiment, one or more of the 17 core nutraceutical ingredients can utilize a co-agent which can include curcumin with black pepper and/or sulforaphane with myrosinase.

TABLE 1

| | Amount (mg)/ | |
|---|---|---|
| Nutraceutical Ingredient | serving (range) | |
| Berberine | 500-1500 | mg |
| Trimethylglycine (TMG) | 500-2000 | mg |
| Microdose Lithium | 1-5 | mg |
| Epigallocatechin-3-gallate (EGCG) | 100-500 | mg |
| Quercetin | 250-1000 | mg |
| Fisetin | 100-1000 | mg |
| Turmeric/Curcumin | 500-2000 | mg |
| Resveritrol | 150-1000 | mg |
| Glutathione | 250-1000 | mg |
| Nicotinamide Mononucleotide (NMN) or | 250-1000 | mg |
| Nicotinamide Riboside (NR) | 100-2000 | mg |
| Calcium Alphaketoglutarate (CaAKG) | 300-2000 | mg |
| Spermidine | 0.5-10 | mg |
| Urolithin A | 250-2000 | mg |
| Sulforaphane | 1-50 | mg |
| Glucosamine | 500-3000 | mg |
| Hyaluronic acid | 100-2400 | mg |
| Sodium Butyrate | 100-3000 | mg |

In another preferred embodiment, any other or additional nutraceutical ingredient(s), such as Pterostilbene, Rhodiola Rosea, Malate (or Malic Acid), L-Theanine, Ginger; Cinnamon, and/or Apigenin, and/or any other suitable nutraceutical ingredient(s), can also be added to the mixture at step 101.

At step 102, the nutraceutical ingredients which are utilized at step 101 can be mixed together by mixing and/or by processing the same in any, and/or during any, appropriate mixing process or operation, cooking process or operation, homogenization process or operation, pasteurization process or operation, and/or any other appropriate process or operation, and/or any combination of the same, which are known to those having skill in the art of the preparation of food compositions, drug compositions, food supplement compositions, chemical compositions and/or mixtures, beverages, drinks, chewable and/or edible foods, food snack bars, energy bars, energy drinks, and/or any other edible food or beverage which can contain supplements such as those of, and/or provided by, the present invention.

At step 102, the nutraceutical ingredients which are utilized at step 101 can be mixed together so as to yield the resulting nutraceutical composition of the present invention. In a preferred embodiment, the resulting nutraceutical composition can be in liquid form or in powdered form. In a preferred embodiment, at step 102, if a powdered form is desired from a resulting liquid nutraceutical composition, an appropriate de-hydration process or operation can be performed in the container or containment system and/or in a second or other container or containment system.

Thereafter, the resulting nutraceutical composition can be in liquid form or in powdered form can be utilized in any appropriate manner, such as in producing a longevity nutraceutical-based beverage, a longevity nutraceutical-based drink, a longevity nutraceutical-based chewable food product, a longevity nutraceutical-based food product such as food bar, a snack bar, a cookie, or a syrup, a longevity nutraceutical-based drink or beverage additive or supplement, or a longevity nutraceutical-based food additive or food supplement.

At step 103, the respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement, can be produced using the nutraceutical composition (also referred to as the “resulting nutraceutical composition”) which was produced at and/or during step 102. In a preferred embodiment, the respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement, can be produced using any respective, suitable, and/or appropriate method(s), technique(s), process(es), and/or operation(s) known by those skilled in the art of food production or manufacturing, beverage or drink production or manufacturing, food supplement production or manufacturing, and/or beverage or drink supplement production or manufacturing.

In a preferred embodiment, at or during step 103, any natural flavoring(s) and/or any artificial flavoring(s) can be added to the respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement.

Thereafter, and once the respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement is produced, the method the preferred embodiment will cease at step 104.

In another preferred embodiment, the present invention is, and provides, a nutraceutical composition which can include a reduced number of nutraceutical ingredients while still providing for the addressing and the combating of all twelve of the pillars of aging. In one such preferred embodiment, twelve or more nutraceutical ingredients can be utilized which can be selected from among the following 24 nutraceutical ingredients:
1. Berberine;
2. Trimethylglycine (TMG);
3. Microdose Lithium;
4. Epigallocatechin-3-gallate (EGCG)
5. Quercetin;
6. Fisetin;
7. Turmeric/Curcumin;
8. Resveritrol;
9. Glutathione;
10. Nicotinamide Mononucleotide (NMN) or Nicotinamide Riboside (NR);
11. Calcium Alphaketoglutarate (CaAKG);
12. Spermidine;
13. Urolithin A;
14. Sulforaphane;
15. Glucosamine;
16. Hyaluronic acid;
17) Sodium Butyrate;
18) Pterostilbene;
19) Rhodiola Rosea;
20) Malate (or Malic Acid);
21) L-Theanine;
22) Ginger;
23) Cinnamon; and
24) Apigenin.

Table 2 lists the above 24 nutraceutical ingredients along with suggested dosages per serving of nutraceutical composition.

TABLE 2

| | Amount (mg)/ | |
|---|---|---|
| Nutraceutical Ingredient | serving (range) | |
| Berberine | 500-1500 | mg |
| Trimethylglycine (TMG) | 500-2000 | mg |
| Microdose Lithium | 1-5 | mg |
| Epigallocatechin-3-gallate (EGCG) | 100-500 | mg |
| Quercetin | 250-1000 | mg |
| Fisetin | 100-1000 | mg |
| Turmeric/Curcumin | 500-2000 | mg |
| Resveritrol | 150-1000 | mg |
| Glutathione | 250-1000 | mg |
| Nicotinamide Mononucleotide (NMN) or | 250-1000 | mg |
| Nicotinamide Riboside (NR) | 100-2000 | mg |
| Calcium Alphaketoglutarate (CaAKG) | 300-2000 | mg |
| Spermidine | 0.5-10 | mg |
| Urolithin A | 250-2000 | mg |
| Sulforaphane | 1-50 | mg |
| Glucosamine | 500-3000 | mg |
| Hyaluronic acid | 100-2400 | mg |
| Ginger | 1000-3000 | mg |
| L-Theanine | 50-200 | mg |
| Malate | 1000-6000 | mg |
| Rhodiola Rosea | 200-600 | mg |
| Pterostilbene | 50-250 | mg |
| Apigenin | 50-500 | mg |
| Cinnamon | 1000-6000 | mg |
| Sodium Butyrate | 100-3000 | mg |

In another preferred embodiment, less than thirteen of the foregoing 24 nutraceutical ingredients, or any other nutraceutical ingredients not identified herein, can also be utilized provided the nutraceutical composition formed thereby can effectively address and combat all twelve of the pillars of aging in an effective manner.

In another preferred embodiment, at least the following thirteen nutraceutical ingredients can be utilized in producing the nutraceutical composition of the present invention:
1. Berberine;
2. Trimethylglycine (TMG);
3. Microdose Lithium;
4. Epigallocatechin-3-gallate (EGCG)
5. Fisetin;
6. Resveritrol;
7. Glutathione;
8. Nicotinamide Mononucleotide (NMN) or Nicotinamide Riboside (NR);
9. Calcium Alphaketoglutarate (CaAKG);
10. Spermidine;
11. Urolithin A;
12. Hyaluronic acid; and
13. Sodium Butyrate

In another preferred embodiment, one or more of any other nutraceutical ingredients identified herein, or any other appropriate and/or suitable nutraceutical ingredient(s) not described herein, can also be utilized along with the above 13 listed nutraceutical ingredients.

In a preferred embodiment, at least the above listed 13 nutraceutical ingredients, including: Berberine, Trimethylglycine (TMG), Microdose Lithium, Epigallocatechin-3-gallate (EGCG), Fisetin, Resveritrol, Glutathione, Nicotinamide Mononucleotide (NMN) or Nicotinamide Riboside (NR), Calcium Alphaketoglutarate (CaAKG), Spermidine, Urolithin A, and Hyaluronic acid, can be utilized to provide for a minimal or a reduced number of nutraceutical ingredients which can effectively address and combat all twelve of the pillars of aging.

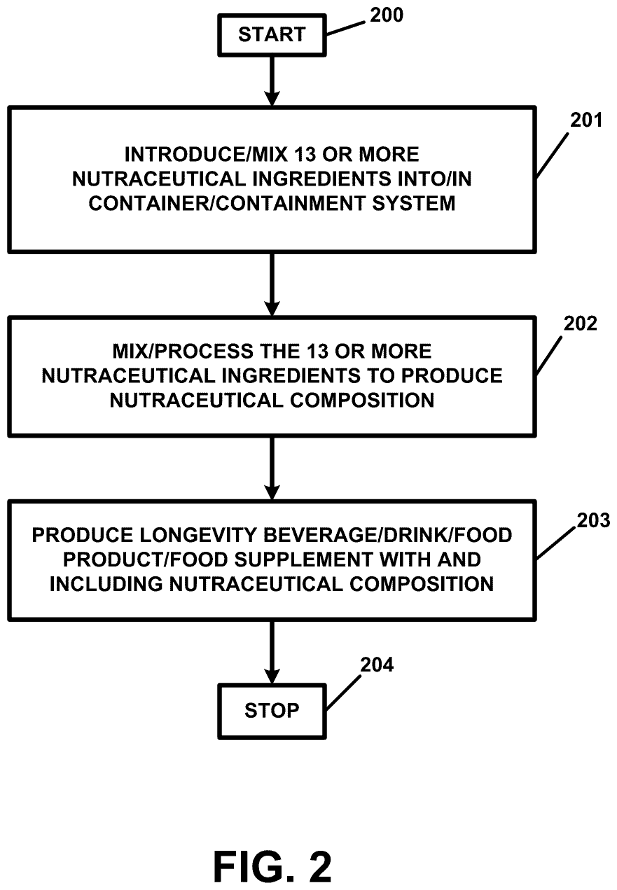

FIG. 2 illustrates another preferred embodiment method for producing a nutraceutical composition of the present invention, using a reduced number (thirteen or more) of nutraceutical ingredients, and any food or beverage products and/or food or beverage supplements containing the same.

With reference to FIG. 2, the process for producing the nutraceutical composition of the present invention and/or the beverages, and/or food products, and/or food supplements, containing the same, commences at step 200. In a preferred embodiment, at step 201, the above-identified 13 nutraceutical ingredients, including Berberine, Trimethylglycine, Microdose Lithium; Epigallocatechin-3-gallate (EGCG), Fisetin, Resveritrol, Glutathione, Nicotinamide Mononucleotide (NMN) or Nicotinamide Riboside (NR), Calcium Alphaketoglutarate, Spermidine, Urolithin A, and Hyaluronic acid, each of which can be in a powdered form and/or in a liquid form, and each of which can be in respective amounts per servings as provided in Table 1 or 2, can be mixed together in any appropriate order or manner in an appropriate container or containment system.

In a preferred embodiment, at step 201, one or more of the 13 nutraceutical ingredients can also be placed in a liposomal preparation, such as, for example, one containing glutathione. In another preferred embodiment, one or more of the 13 core nutraceutical ingredients can utilize a co-agent which can include curcumin with black pepper (which contains Piperine) and/or sulforaphane with myrosinase.

In another preferred embodiment, any other or additional nutraceutical ingredient(s), such as Pterostilbene, Rhodiola Rosea, Malate (or Malic Acid), L-Theanine, Ginger; Cinnamon, and/or Apigenin, and/or any other suitable nutraceutical ingredient(s) from Table 1 or Table 2, can also be added to the mixture at step 201.

At step 202, the nutraceutical ingredients which are utilized at step 201 can be mixed together by mixing and/or by processing the same in any, and/or during any, appropriate mixing process or operation, cooking process or operation, homogenization process or operation, pasteurization process or operation, and/or any other appropriate process or operation, and/or any combination of the same, which are known to those having skill in the art of the preparation of food compositions, drug compositions, food supplement compositions, chemical compositions and/or mixtures, beverages, drinks, chewable and/or edible foods, food snack bars, energy bars, energy drinks, and/or any other edible food or beverage which can contain supplements such as those of, and/or provided by, the present invention.

At step 202, the nutraceutical ingredients which are utilized at step 201 can be mixed together so as to yield the resulting nutraceutical composition of the present invention. In a preferred embodiment, the resulting nutraceutical composition can be in liquid form or in powdered form. In a preferred embodiment, at step 202, if a powdered form is desired from a resulting liquid nutraceutical composition, an appropriate de-hydration process or operation can be performed in the container or containment system and/or in a second or other container or containment system.

Thereafter, the resulting nutraceutical composition can be in liquid form or in powdered form can be utilized in any appropriate manner, such as in producing a longevity nutraceutical-based beverage, a longevity nutraceutical-based drink, a longevity nutraceutical-based chewable food product, a longevity nutraceutical-based food product such as food bar, a snack bar, a cookie, or a syrup, a longevity nutraceutical-based drink or beverage additive or supplement, or a longevity nutraceutical-based food additive or food supplement.

At step 203, the respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement, can be produced using the nutraceutical composition (also referred to as the “resulting nutraceutical composition”) which was produced at and/or during step 202. In a preferred embodiment, the respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement, can be produced using any respective, suitable, and/or appropriate method(s), technique(s), process(es), and/or operation(s) known by those skilled in the art of food production or manufacturing, beverage or drink production or manufacturing, food supplement production or manufacturing, and/or beverage or drink supplement production or manufacturing.

In a preferred embodiment, at or during step 203, any natural flavoring(s) and/or any artificial flavoring(s) can be added to the respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement.

Thereafter, and once the respective longevity nutraceutical-based beverage, longevity nutraceutical-based drink, longevity nutraceutical-based chewable food product, longevity nutraceutical-based food product such as food bar, snack bar, cookie, brownie, or syrup, longevity nutraceutical-based drink or beverage additive or supplement, or longevity nutraceutical-based food additive or food supplement is produced, the method the preferred embodiment will cease at step 204.

As noted above, in another preferred embodiment, the nutraceutical composition of the present invention can also be produced from less than thirteen nutraceutical ingredients, with the minimum number only being limited depending upon the addressing and effective combating of all twelve of the pillars of aging.

The nutraceutical composition of the present invention can be used to provide a pre-packaged beverage or drink, a pre-packaged tea beverage or drink, a pre-packaged coffee beverage or drink, a pre-packaged red wine beverage or drink, a pre-packaged carbonated beverage or drink, a pre-packaged caffeinated beverage or drink, a product which can be offered in powdered form, a chewable food product, a food product, a food snack bar product, a food supplement product which can be provided in liquid form or in powdered form, and/or any other consumable beverage, drink, edible product, food product, or food supplement. In a preferred embodiment, the present invention can provide a nutraceutical composition which can be consumed in any beverage, drink, edible, food product, or food supplement, daily by itself as a stand alone supplement and/or as a daily solution to address and combat the problem of aging while dispensing with the need to obtain and mix the individual ingredients prior to consumption.

In another preferred embodiment, the nutraceutical composition of the present invention can also contain the nutraceutical Fucoidan in a range of 100-4000 mg. In a preferred embodiment, the Fucoidan can be an additional ingredient in any nutraceutical composition of, and prepared pursuant to, the present invention. In another preferred embodiment, Fucoidan can be used as a suitable substitute for any ingredient in any nutraceutical composition of, and prepared pursuant to, the present invention.

In another preferred embodiment, the nutraceutical composition of the present invention can also contain the nutraceutical Cacao in any suitable and safe amount or range provided that said amount does not exceed any safe or recommended daily dosage amount or range. In a preferred embodiment, the Cacao can be an additional ingredient in any nutraceutical composition of, and prepared pursuant to, the present invention. In another preferred embodiment, Cacao can be used as a suitable substitute for any ingredient in any nutraceutical composition of, and prepared pursuant to, the present invention.

In another preferred embodiment, the nutraceutical composition of the present invention can be manufactured and sold in powder form as a powder which can be added to, and/or mixed with, any drink or beverage, or which can be added to, and/or mixed with, any food. In a preferred embodiment, the nutraceutical composition of the present invention, which can be manufactured as a powder, can be flavored with any appropriate and/or suitable flavor or flavoring, which flavor or flavoring can be, or can include, a natural flavor or flavoring or any combination of natural flavors or flavorings.

In another preferred embodiment, the nutraceutical composition of the present invention, which can be manufactured as a powder, can be flavored with any appropriate and/or suitable flavor or flavoring, which flavor or flavoring can be, or can include, an artificial flavor or flavoring or any combination of artificial flavors or flavorings.

In another preferred embodiment, the nutraceutical composition of the present invention, which can be manufactured as a powder, can be flavored with any appropriate and/or suitable flavor or flavoring, which flavor or flavoring can be, or can include, any combination of a natural flavor or flavoring and an artificial flavor or flavoring or any combination of an artificial flavor or flavoring and one or more natural flavor(s) or flavoring(s) or any combination of a natural flavor or flavoring and one or more artificial flavor(s) or flavoring(s).

In another preferred embodiment, the nutraceutical composition of the present invention, which can be manufactured as a powder, can also be non-flavored.

In a preferred embodiment, the nutraceutical composition of the present invention, which can be manufactured as a powder, can also produced with caffeine as a caffeinated product. In another preferred, the nutraceutical composition of the present invention, which can be manufactured as a powder, can also produced with without caffeine as a non-caffeinated product or as a de-caffeinated product.

In another preferred embodiment, nutraceutical composition of the present invention can also be produced or manufactured as a concentrated liquid or as a syrup which can be added to, and/or mixed with, any drink or beverage, or which can be added to, and/or mixed with, any food. In a preferred embodiment, the nutraceutical composition of the present invention, which can also be produced as a concentrated liquid or as a syrup, can be flavored with any natural flavor or flavoring, or can be flavored with any artificial flavor or flavoring, or can be flavored with any combination of one or more natural flavor(s) or flavoring(s) and one or artificial flavor(s) or flavoring(s).

In another preferred embodiment, the nutraceutical composition of the present invention, which can also be produced as a concentrated liquid or as a syrup, can be unflavored. In another preferred embodiment, the nutraceutical composition of the present invention, which can also be produced as a concentrated liquid or as a syrup, can be caffeinated or can be uncaffeinated or de-caffeinated.

In another preferred embodiment, the herein-identified nutraceutical ingredients, including, but not limited to, Berberine, Trimethylglycine (TMG), Microdose Lithium, Epigallocatechin-3-gallate (EGCG), Fisetin, Resveritrol, Glutathione, Nicotinamide Mononucleotide (NMN) or Nicotinamide Riboside (NR), Calcium Alphaketoglutarate (CaAKG), Spermidine, Urolithin A, and Hyaluronic acid, or any combination of any of the herein-identified nutraceutical ingredients, which can include any of the ingredients identified in Table 2 and/or Fucoidan and/or cacao, can also be utilized to provide for a nutraceutical composition which can effectively address and combat all twelve of the pillars of aging.

In another preferred embodiment, the nutraceutical composition of the present invention can be mixed and/or processed in order to yield a nutraceutical composition in a powder form or powdered form which can be added to, or mixed into and/or with, water or any suitable liquid drink or beverage, or a juice, coffee, tea, or any other type or kind of beverage. In a preferred embodiment, the nutraceutical composition of the present invention can be mixed and/or processed in order to yield a nutraceutical composition in a powder form or powdered form which can be added to, or mixed into and/or with, any cold liquid or beverage or any hot or warm liquid of beverage.

In a preferred embodiment, for example, the nutraceutical composition in powder form or powdered form can be packaged in a stick package, in a stick packet, or/and in any suitable packet or packaging. In a preferred embodiment, such a packaged nutraceutical composition provided in powder form can be mixed into or with any water or other liquid or beverage.

In another preferred embodiment, the nutraceutical composition of the present invention can be mixed and/or processed in order to yield a nutraceutical composition in a liquid form or in a syrup form, which nutraceutical composition can be added to, or mixed into and/or with, water or any suitable liquid drink or beverage, or a juice, coffee, tea, or any other type or kind of beverage.

In another preferred embodiment, the nutraceutical composition of the present invention, in a liquid form or in a syrup form, can be added to, or mixed into and/or with, any cold liquid or beverage or any hot or warm liquid of beverage. In a preferred embodiment, for example, the nutraceutical composition in liquid form or in syrup form can be packaged in any suitable container, bottle, or can, made of any suitable material. In a preferred embodiment, such a packaged nutraceutical composition, in liquid form or in syrup form can be mixed into or with any water or other liquid or beverage.

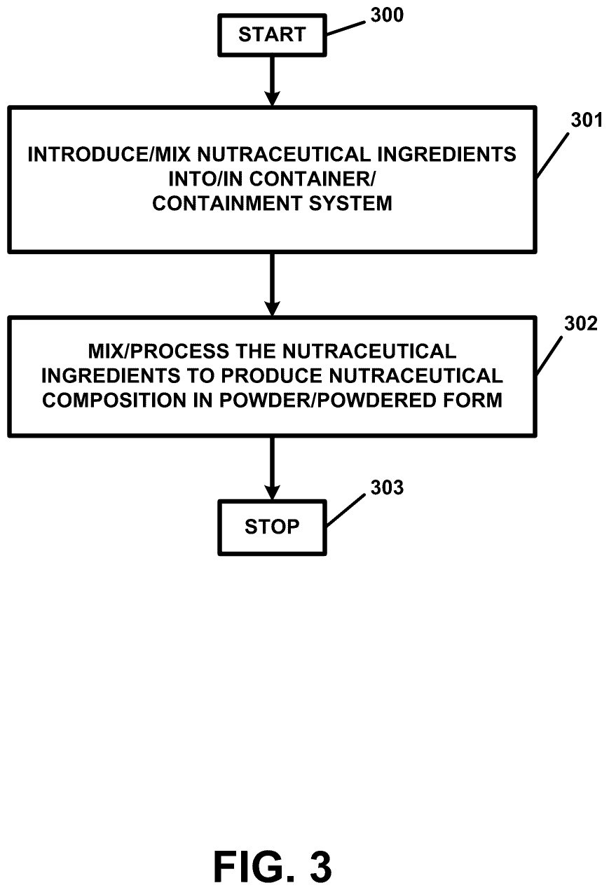

FIG. 3 illustrates another preferred embodiment method for producing the nutraceutical composition of the present invention. With reference to FIG. 3, the process for producing the nutraceutical composition of the present invention in a powder form or powdered form commences at step 300.

In a preferred embodiment, at step 301, the nutraceutical ingredients, including, but not limited to, Berberine, Trimethylglycine, Microdose Lithium; Epigallocatechin-3-gallate (EGCG), Fisetin, Resveritrol, Glutathione, Nicotinamide Mononucleotide (NMN) or Nicotinamide Riboside (NR), Calcium Alphaketoglutarate, Spermidine, Urolithin A, and Hyaluronic acid, and/or any of other ingredients identified in Table 2, and/or Fucoidan, and/or cacao, each of which can be in their respective amounts per servings as provided in Table 1 or Table 2, or as provided elsewhere in this patent application, and/or as desired, can be mixed together in any appropriate order or manner in an appropriate container or containment system.

In a preferred embodiment, at step 301, one or more of the nutraceutical ingredients can also be placed in a liposomal preparation, such as, for example, one containing glutathione. In another preferred embodiment, one or more of the nutraceutical ingredients can also utilize a co-agent which can include curcumin with black pepper (which contains Piperine) and/or sulforaphane with myrosinase.

At step 302, the nutraceutical ingredients which are utilized at step 301 can be mixed together by mixing and/or by processing the same in any, and/or during any, appropriate mixing process or operation, which are known to those having skill in the art of the preparation of powder compositions or powdered compositions and/or mixtures. In another preferred embodiment, any natural flavor or flavoring, and/or any artificial flavor or flavoring, can also be added to the mixture of the nutraceutical ingredients at step 302. In another preferred embodiment, caffeine can also be added to the mixture of the nutraceutical ingredients at step 302.

At step 302, the nutraceutical ingredients, which are utilized at step 301, can be mixed together and/or processed so as to yield the resulting nutraceutical composition of the present invention in a powder form or powdered form.

Thereafter, once the nutraceutical composition of the present invention in a powder form or powdered form is prepared, the method the preferred embodiment of FIG. 3 will cease at step 303.

When it is desired to add or mix the nutraceutical composition, in a powder form or powdered form, with any desired water, liquid, or beverage, the same can simply be added to, and/or mixed into or with, the desired water, liquid, or beverage.

In another preferred embodiment, the nutraceutical composition of the present invention can be prepared in liquid form or in syrup form.

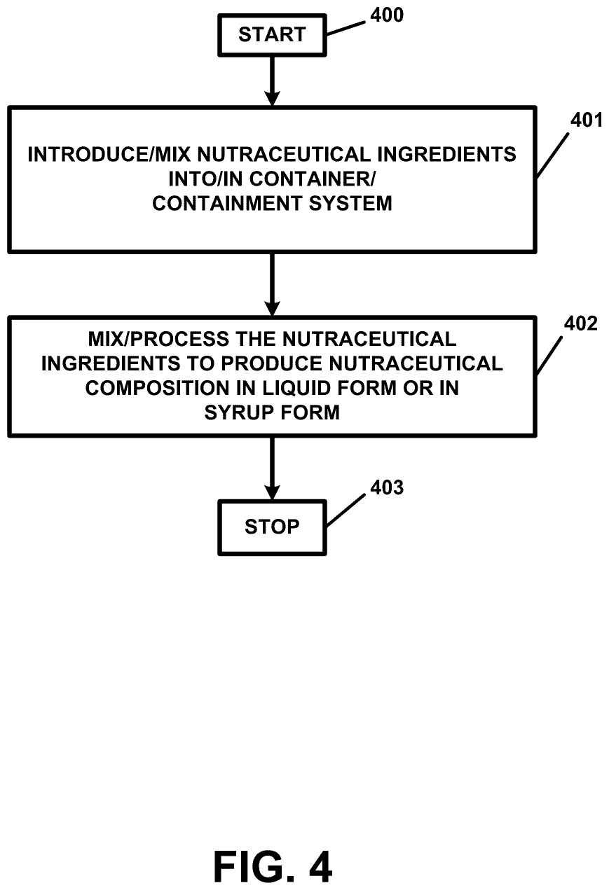

FIG. 4 illustrates another preferred embodiment method for producing the nutraceutical composition of the present invention in a liquid form or in a syrup form. With reference to FIG. 4, the process for producing the nutraceutical composition of the present invention in a liquid form or in a syrup form commences at step 400.

In a preferred embodiment, at step 401, the nutraceutical ingredients, including, but not limited to, any combination of those including Berberine, Trimethylglycine, Microdose Lithium; Epigallocatechin-3-gallate (EGCG), Fisetin, Resveritrol, Glutathione, Nicotinamide Mononucleotide (NMN) or Nicotinamide Riboside (NR), Calcium Alphaketoglutarate, Spermidine, Urolithin A, and Hyaluronic acid, and/or any of other ingredients identified in Table 2, and/or Fucoidan, and/or cacao, each of which can be in their respective amounts per servings as provided in Table 1 or Table 2, or as provided elsewhere in this patent application, and/or as desired, can be mixed together in any appropriate order or manner in an appropriate container or containment system.

In a preferred embodiment, at step 401, one or more of the nutraceutical ingredients can also be placed in a liposomal preparation, such as, for example, one containing glutathione. In another preferred embodiment, one or more of the nutraceutical ingredients can also utilize a co-agent which can include curcumin with black pepper (which contains Piperine) and/or sulforaphane with myrosinase.

At step 402, the nutraceutical ingredients which are utilized at step 401 can be mixed together by mixing and/or by processing the same in any, and/or during any, appropriate mixing process or operation, which are known to those having skill in the art of the preparation of a liquid product or liquid form product or a syrup product or a syrup form product. In another preferred embodiment, any natural flavor(s) or flavoring(s), and/or any artificial flavor(s) or flavoring(s), can also be added to the mixture of the nutraceutical ingredients at step 402. In another preferred embodiment, caffeine can also be added to the mixture of the nutraceutical ingredients at step 402.

At step 402, the nutraceutical ingredients which are utilized at step 401 can be mixed together and/or processed so as to yield the resulting nutraceutical composition of the present invention in a liquid form or in a syrup form.

Thereafter, once the nutraceutical composition of the present invention in a liquid form or in a syrup form is prepared, the method the preferred embodiment of FIG. 4 will cease at step 403.

When it is desired to add or mix the nutraceutical composition, in a liquid for or in a syrup form, with any desired water, liquid, or beverage, the same can simply be added to, and/or mixed into or with, the desired water, liquid, or beverage.

In a preferred embodiment, the present invention can provide a food product containing the nutraceutical composition which can be a food supplement which can be added to a food, a beverage, or a drink.

In a preferred embodiment, the present invention can provide a food product containing the nutraceutical composition which can be a food supplement which can be applied to a food, a beverage, or a drink. In a preferred embodiment, the food product or food supplement of the present invention can also be sprinkled or poured on or over, or into, any food, beverage, or drink.

It is submitted that the nutraceutical composition of the present invention and any products containing the same can provide benefits in and to all major organ systems. These benefits could include, but are not limited to, improved metabolic health, improved cardiovascular health, decreased inflammation, enhanced anti-oxidant benefits, cancer prevention, improved gastrointestinal health, neuroprotection, mood stabilization, improved cognitive health, improved brain health, improved and enhanced antibacterial and anti-viral support, improved and enhanced immune system support, improved respiratory health, improved and enhanced exercise performance and recovery, improved skin health, improved joint health, improved liver health, improved blood sugar control, improved weight management, improved detoxification, improved cellular health and repair, improved energy metabolism, improved protein synthesis, improved wound healing, improved cellular health, improved mitochondrial health, and improved and enhanced life span extension.

The nutraceutical composition of the present invention serves to address and combat the twelve pillars of aging. Further, the nutraceutical composition of the present invention serves to address and combat the twelve pillars of aging in an efficient and effective manner.

Applicant hereby incorporates by reference herein all processes, proprietary and non-proprietary, which are known to those skilled in the pertinent and respective art(s), as of the date of the filing of this patent application, in order to perform any of the method(s), technique(s), process(es), and/or operation(s), needed or desired in performing any of the food production or manufacturing, the beverage or drink production or manufacturing, the food supplement production or manufacturing, and/or the beverage or drink supplement production or manufacturing, in producing any beverages, drinks, foods, and/or food supplements, described herein as being produced using any of the nutraceutical compositions of the present invention.

Applicant also hereby incorporates by reference herein the subject matter and teachings of U.S. Pat. No. 11,839,622, entitled “CONSUMABLE NUTRACEUTICAL COMPOSITION”, the subject matter and teachings of which are incorporated by reference herein in their entirety, as if to be fully restated herein, so as incorporate the teachings of same, and so as to improve upon the teachings of the same.

In another preferred embodiment, as well as in any and/or all of the embodiments described herein, the nutraceutical composition of the present invention can also be produced so as to include any types or kinds of ingredients typically found in energy drinks, protein drinks, vitamin drinks, energy foods, protein foods, vitamin-enriched foods, energy food and/or beverage supplements, protein food and/or beverage supplements, and/or vitamin food and/or beverage supplements.

While the present invention has been described and illustrated in various preferred and alternate embodiments, such descriptions are merely illustrative of the present invention and are not to be construed to be limitations thereof. In this regard, the present invention encompasses all modifications, variations, and/or alternate, embodiments, with the scope of the present invention being limited only by the claims which follow.

What is claimed is:

1. A nutraceutical composition, wherein a serving of the nutraceutical composition consists at least of Berberine in an amount of about a range of 500 to 1500 mg, Trimethylglycine (TMG) in an amount of about a range of 500 to 2000 mg, Microdose Lithium in an amount of about a range of 1 to 5 mg, Epigallocatechin-3-gallate (EGCG) in an amount of about a range of 100 to 500 mg, Quercetin in an amount of about a range of 250 to 1000 mg, Fisetin in an amount of about a range of 100 to 1000 mg, Turmeric/Curcumin in an amount of about a range of 500 to 2000 mg, Resveritrol in an amount of about a range of 150 to 1000 mg, Glutathione in an amount of about a range of 250 to 1000 mg, Nicotinamide Mononucleotide (NMN) in an amount of about a range of 250 to 1000 mg or Nicotinamide Riboside (NR) in an amount of about a range of 100 to 2000 mg, Calcium Alphaketoglutarate (CaAKG) in an amount of about a range of 300 to 2000 mg, Spermidine in an amount of about a range of 0.5 to 10 mg, Urolithin A in an amount of about a range of 250 to 2000 mg, Sulforaphane in an amount of about a range of 1 to 50 mg, Glucosamine in an amount of about a range of 500 to 3000 mg, Hyaluronic acid in an amount of about a range of 100 to 240 mg, Fucoidan in a range of 100-4000 mg, and Sodium Butyrate in an amount of about a range of 100-3000 mg.

2. The nutraceutical composition of claim 1, wherein the nutraceutical composition further consists of Ginger in an amount of about a range of 1000 to 3000 mg per serving.

3. The nutraceutical composition of claim 1, wherein the nutraceutical composition further consists of Malate in an amount of about a range of 1000 to 6000 mg per serving.

4. The nutraceutical composition of claim 1, wherein the nutraceutical composition further consists of Cacao.

5. The nutraceutical composition of claim 1, wherein the nutraceutical composition is produced in powder form.

6. The nutraceutical composition of claim 1, wherein the nutraceutical composition is produced in liquid form.

7. The nutraceutical composition of claim 1, wherein the nutraceutical composition is produced in syrup form.

8. The nutraceutical composition of claim 1, wherein the nutraceutical composition further consists of Pterostilbene in an amount of about a range of 50 to 250 mg per serving.

9. The nutraceutical composition of claim 1, wherein the nutraceutical composition further consists of L-Theanine in an amount of about a range of 50 to 200 mg per serving.

10. The nutraceutical composition of claim 1, wherein the nutraceutical composition further consists of Cinnamon in an amount of about a range of 1000 to 6000 mg per serving.

11. The nutraceutical composition of claim 1, wherein the nutraceutical composition further consists of Apigenin in an amount of about a range of 50 to 500 mg per serving.

12. The nutraceutical composition of claim 1, wherein the nutraceutical composition further consists of Rhodiola Rosea in an amount of about a range of 200 to 600 mg per serving.

13. The nutraceutical composition of claim 1, wherein the nutraceutical composition is a longevity product.

14. The nutraceutical composition of claim 1, wherein the nutraceutical composition further consists of an ingredient of an energy drink.

15. The nutraceutical composition of claim 1, wherein the nutraceutical composition further consists of an ingredient of a protein drink.

16. The nutraceutical composition of claim 1, wherein the nutraceutical composition further consists of an ingredient of a vitamin drink.

17. The nutraceutical composition of claim 1, wherein the nutraceutical composition is produced by a mixing process or operation, a cooking process or operation, an homogenization process or operation, or a pasteurization process or operation.

18. The nutraceutical composition of claim 1, wherein the nutraceutical composition is caffeinated.

19. The nutraceutical composition of claim 1, wherein the nutraceutical composition is de-caffeinated.

20. The nutraceutical composition of claim 1, wherein the nutraceutical composition is mixable with water, coffee, tea, or a juice.
